(19) United States
(12) Patent Application Publication
(10) Pub. No.: US 2008/0114971 A1
(43) Pub. Date: May 15, 2008

(54) BRANCH HISTORY TABLE FOR DEBUG

(76) Inventors: Nathan D. Fontenot, Cedar Park, TX (US); Jacob Lorien Moilanen, Austin, TX (US); Joel Howard Schopp, Austin, TX (US); Michael Thomas Strosaker, Austin, TX (US)

Correspondence Address: IBM CORP (YA);C/O YEE & ASSOCIATES PC, P.O. BOX 802333, DALLAS, TX, 75380, US

(21) Appl. No.: 11/559,426

(22) Filed: Nov. 14, 2006

(51) Int. Cl. G06F 9/38; G06F 9/318

(52) U.S. Cl. 712/227; 712/244; 712/E09.045; 712/E09.035

(57) ABSTRACT

A computer implemented method, apparatus, and computer program product for preserving branch history data. The process creates a branch history table in a buffer. The process saves an address for each executed branch instruction that occurs during execution of code in the branch history table to form branch history data. In response to detecting an exception, the process saves the branch history data to an allocated memory space to form a branch history snapshot.

### BACKGROUND OF THE INVENTION

1. Field of the Invention

The present invention is related generally to a data processing system and in particular to a method and apparatus for a branch history table. More particularly, the present invention is directed to a computer implemented method, apparatus, and computer usable program code for saving the addresses of branch instructions in a branch history table for use in debugging.

2. Description of the Related Art

An exception condition is a problem in a computer hardware component or software component, such as a program or application, that causes the computer to stop performing in an expected manner and/or stop responding to other parts of the computer. An exception condition is sometimes referred to as a bug in the computer hardware or software. When an exception occurs in a given program, the program will frequently appear to freeze. If the exception or bug occurs in a critical component of the data processing system, the entire data processing system may crash.

When an exception or bug is detected, a debug process can be performed by a debugger program to delete, remove, or correct the problem with the program or application. The exception is generally caused by a bad instruction in the program code. In order to correct the problem with the bad instruction, a user must first locate or identify the bad instruction that caused the exception occurrence or computer system crash.

During a debug process, it is often difficult for a user to identify the code path through the assembly language code that caused the exception condition and/or crash. Current methods of debugging include performing register forensics. Register forensics is a method of analyzing register contents to determine the code path. This method can be uncertain and misleading, especially when the compiler performs assembly optimization.

Assembly optimization is performed by a compiler. During compilation, a compiler translates a high level language, such as C or C++, into assembly language, also referred to as machine code that is executable by a computer processor. During compilation, the compiler can alter the structure of the original high level language code in the assembly code so that the assembly code will perform more efficiently during processing. For example, the compiler can combine two or more loops in a high level language code into a single loop in the assembly language to optimize execution of the code.

In cases where the compiler has performed assembly optimization, it can be even more difficult for a user to identify the code path of loops and branches in the assembly code due to the alterations in the code that occur during optimization. In a majority of cases, it is almost impossible to determine the code path and only reproduction of the failure can identify the bug. Being able to determine the code path is even more important on a rare error-path crash due to the substantial duration of time and effort required to reproduce the failure.

A branch predictor is a part of a computer processor that determines whether a branch in the instruction flow will be taken. Branch prediction data can be stored in a branch prediction table in a buffer on the processor. These branch prediction tables are used by the processor to determine if a branch is predicted to be taken or not. If a branch is predicted to be taken, the processor can pre-fetch data necessary for executing the branch instructions to improve processing performance.

For example, in PowerPC64, there are three branch predictors. The branch predictors include a local predictor, a global predictor, and a selector table. A local predictor is a hash array of branch addresses which indicate if a branch was taken or not taken when the branch was last encountered in the code. A global predictor is a bit vector that indicates the branch pattern last taken. Each bit in the global predictor table indicates whether a last branch was taken or not taken. Finally, a selector table indicates which of the first two tables most accurately predicted which branch instructions would be taken.

Currently, some branch prediction tables can save prior branches, such as indicating whether a branch instruction was last taken or not taken. However, these branch prediction tables do not save the order of the branches. Thus, a user is unable to discern the code path based on the information in the branch prediction table. Other branch prediction tables save a pattern of branches, but the pattern does not have branch addresses associated with the branches. Therefore, even using these branch predictors, a user cannot determine what the actual paths of the last branches were prior to the occurrence of an exception condition and/or computer system crash. In addition, the information in the branch prediction table is continually overwritten, even after the occurrence of an exception condition. As a result, branch prediction table data is frequently unavailable when a debug operation is performed. Thus, a user is frequently unable to determine the actual code path during a debug operation.

### SUMMARY OF THE INVENTION

The illustrative embodiments provide a computer implemented method, apparatus, and computer program product for preserving branch history data. In one embodiment, the process creates a branch history table in a buffer. The process saves an address for each executed branch instruction that occurs during execution of code in the branch history table to form branch history data. In response to detecting an exception, the process saves the branch history data to an allocated memory space to form a branch history snapshot.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram illustrating a dataflow when a branch history table is created and utilized for debugging in accordance with an illustrative embodiment;

FIG. 4 is a flowchart illustrating a process for creating a branch history table in accordance with an illustrative embodiment;

FIG. 5 is a flowchart illustrating a process for saving branch history data from a branch history table to main memory for use in debugging in accordance with an illustrative embodiment; and

FIG. 6 is a flowchart illustrating a process for accessing branch history data by a debugger in accordance with an illustrative embodiment.

### DETAILED DESCRIPTION OF THE PREFERRED EMBODIMENT

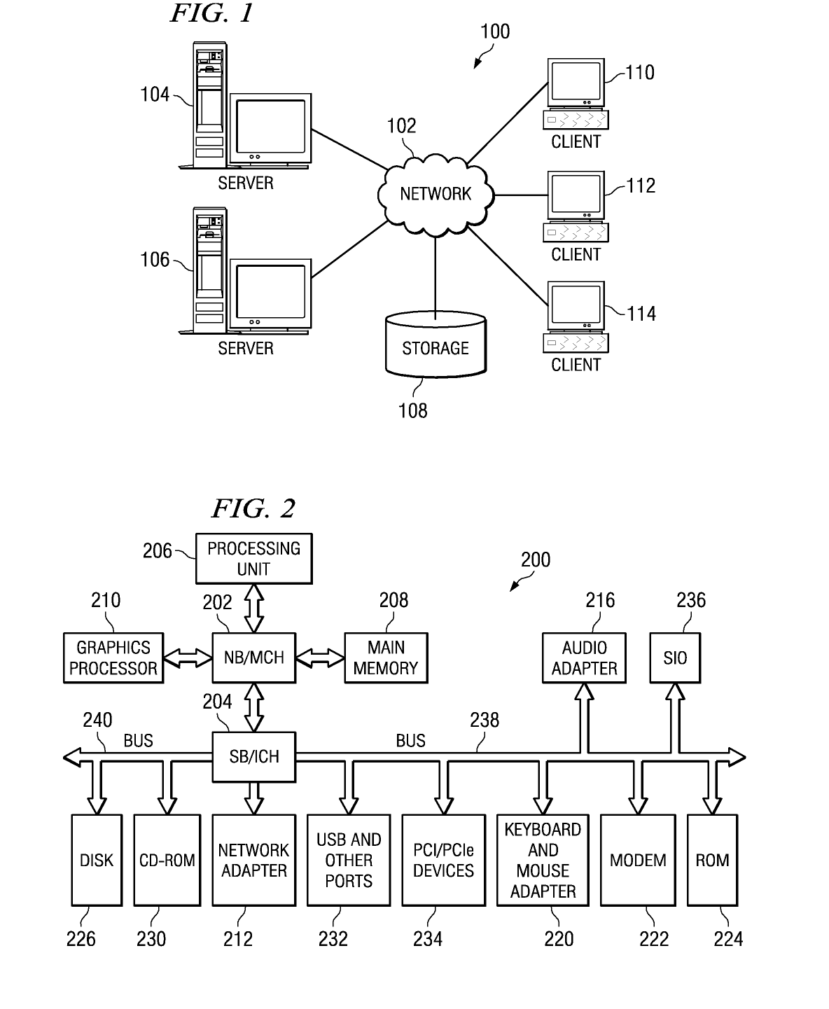

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

When an exception condition occurs, a debug process can be performed by a debugger program to delete, remove, or correct a problem with a program or application that caused the exception condition. However, the debugger needs to identify the code path that led to the exception. During a debug process, it is often difficult for a user or debugger to identify the code path through the assembly language code that caused the exception condition and/or crash.

Current methods of debugging include performing register forensics to determine the code path. This method can be uncertain and misleading, especially when the compiler performs assembly optimization. In a majority of cases, it is almost impossible to determine the code path and only reproduction of the failure can identify the bug. Being able to determine the code path is even more important on a rare error-path crash due to the substantial duration of time and effort required to reproduce the failure.

A branch predictor is a part of a computer processor that determines whether a branch in the instruction flow will be taken. Branch prediction data can be stored in a branch prediction table in a buffer on the processor. These branch prediction tables are used by the processor to determine if a branch is predicted to be taken or not. If a branch is predicted to be taken, the processor can pre-fetch data necessary for executing the branch instructions to improve processing performance.

The illustrative embodiments recognize that a branch prediction table is not useful for debug operations because it does not capture the necessary data and the branch prediction data is continually being overwritten.

Therefore, the illustrative embodiments provide computer implemented method, apparatus, and computer program product for preserving branch history data. In one embodiment, the process creates a branch history table in a buffer. The process saves an address for each executed branch instruction to the branch history table to form a set of branch history data. In response to detection of an exception, the process saves the set of branch history data to an allocated memory space to form a branch history snapshot. In this example, the buffer is a circular buffer located on a processor chip. However, in accordance with the illustrative embodiments, the buffer may be any type of known or available buffer, including, but not limited to, circular buffers.

In this example, the allocated memory space is a memory location in main memory. The process allocates memory space in main memory for the branch history snapshot to form the allocated memory space. The process sets a register to point to the allocated memory space. To save branch history data to the allocated memory space, the process checks the register to determine the location of the allocated memory space and then saves the branch history data to the allocated memory space pointed to by the register.

In response to identifying an exception condition that requires debugging, the process calls a debugger on the operating system kernel. The debugger retrieves the branch history snapshot from the allocated memory space and performs a debug operation based on the branch history snapshot. The branch history snapshot identifies addresses of executed branch instructions.

In another illustrative embodiment, the process sends the branch history snapshot to a debugger on a remote data processing system for use in performing debugging operations. The debugger reads the branch history data from the branch history snapshot and identifies an instruction causing the exception based on the branch history data.

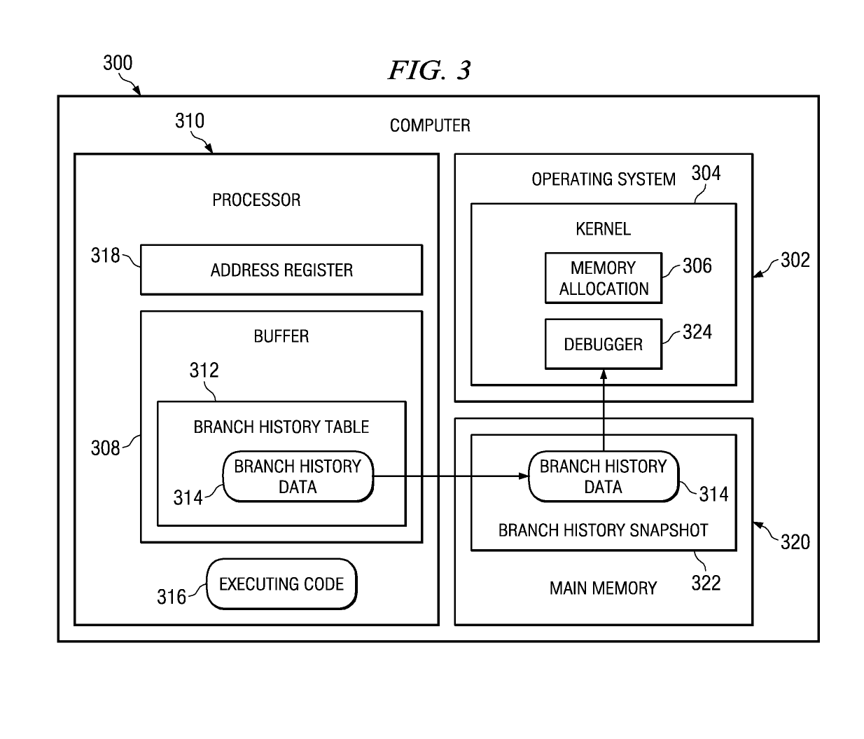

FIG. 3 is a block diagram illustrating a dataflow when a branch history table is created and utilized for debugging in accordance with an illustrative embodiment. Computer 300 is any type of computing device, such as a personal computer, laptop, personal digital assistant, or any other computing device depicted in FIGS. 1 and 2.

Operating system 302 is software on computer 300 for managing hardware and software resources on computer 300. Operating system 302 includes kernel 304. Kernel 304 is software for managing resources on computer 300, such as processor resources, input and output (I/O) resources, and memory. Kernel 304 is an abstraction layer between hardware and software on computer 300. Memory allocation 306 is a software component in kernel 304 for allocating memory for storing data.

Buffer 308 is a region of memory on processor 310 for temporarily holding data, such as branch history data 314 in branch history table 312. Branch history table 312 is a data structure for storing data, such as branch history data 314. Branch history data 314 includes addresses of branch instructions in executing code 316. Addresses of branch instructions are saved in branch history table 312 as each branch instruction is executed.

Buffer 308 can be any type of known or available buffer. In this example, buffer 308 is a circular buffer. A circular buffer is a buffer that writes data into the buffer beginning at a beginning position in the buffer, such as a location 1. Subsequent data is written into buffer slots in a sequential manner until the end of the buffer is reached. For example, if a buffer has 3 memory slots, data is written into slot 1, slot 2, and then slot 3. When the buffer is full, new data is written into the buffer at the beginning of the buffer, at slot 1. This process continues writing new data into buffer slots in this sequential manner. In other words, data is written over the oldest data in the buffer in a round robin fashion. Thus, data in the buffer is continuously being overwritten by new data.

Processor 310 is a processor such as processor unit 206 in FIG. 2. Processor 310 is any type of known or available processor for executing a process on computer 300, including but not limited to, a central processing unit (CPU) or a digital signal processor (DSP). In this illustrative example, processor 310 is a CPU.

Executing code 316 is a program, application, process, task, code, or thread that is currently executing on processor 310. Executing code 316 includes branch instructions. A branch is a point in a program, application, process, task, code, or thread where the flow of instruction execution can change. Ordinarily, code is executed one instruction at a time, moving from the current instruction to the next or adjacent instruction to the current instruction in a sequential manner. However, a branch can cause execution of instructions to change from execution of the next instruction in the sequence of instructions to execution of an instruction located at some other place in memory. In other words, a branch can cause the execution of code to jump from the location of the current instruction code to a non-sequential instruction, such as in a function call, loop, or conditional statement. In a high level language, a branch can include a conditional statement, subroutine call, or GOTO statement.

During initialization of computer 300, memory allocation 306 allocates memory for storing data. In this example, memory allocation 306 allocates memory space in main memory for storing branch history data 314 from branch history table 312. Memory is allocated by calling a function for allocating memory, such as malloc( ), calloc( ), or any other code or function for dynamically allocating memory. In this example, memory allocation 306 calls calloc( ) to dynamically allocate memory for branch history data 314 in main memory 320.

After allocating memory in main memory 320 for branch history data 314, kernel 304 creates a pointer in address register 318 that points to the location of the allocated memory for branch history data 314.

Address register 318 is a processor register for storing a memory address. Address register 318 is located on processor 310. Address register 318 provides quick access to memory addresses for branch history table 312. Address register 318 can be any type of register for holding an address or pointing to a memory location on processor 310, including but not limited to, an address register, a general purpose register, a special purpose register, or an index register.

During execution of executing code 316, processor 310 stores addresses for each branch instruction in branch history table 312. Branch history data 312 includes the addresses for each branch instruction in branch history table 312.

Upon the occurrence of an exception condition, processor 310 retrieves the address for the location of memory allocated for branch history data 314 from address register 318. An exception condition includes detection of an exception, a system crash, application crash, segmentation fault occurrence, or any other detection of a program, process, application, thread, or code failing to perform an expected function. Processor 310 saves branch history data 314 in branch history table 312 to main memory 320. Main memory 320, also referred to as primary storage, internal memory, or main storage, is computer memory accessible to processor 310 without the use of input and output channels. Main memory 320 is generally very fast. Main memory 320 includes, but is not limited to, random access memory (RAM), read-only memory (ROM), non-volatile random access memory (NVRAM), and any other type of known or available main memory. In this example, main memory is random access memory (RAM).

Branch history data 314 stored in main memory 320 is branch history snapshot 322. Branch history snapshot 322 is branch history data preserved in main memory 320 for use in debugging processes. Ordinarily, branch history data 314 written to branch history table 312 in buffer 308 is overwritten when buffer 308 becomes full. However, when processor 310 detects an exception condition and saves branch history data 314 to main memory 320, branch history data 314 is a snapshot of branch history addresses at the time of the exception condition occurrence and/or detection. Thus, branch history snapshot 322 provides a picture of branch instructions executing at the time of the exception and/or prior to the exception condition for use in debugging processes.

Upon detection of the exception condition, kernel 302 calls debugger 324. Debugger 324 is software or a combination of hardware and software for testing and debugging software programs, applications, and/or computer hardware. Debugging is the process of identifying and removing defects or bugs in program code or hardware so that the hardware and software will behave in an expected or desired manner.

Debugger 324 is any type of known or available debugger. In this example, debugger 324 is located locally to computer 300. However, in another example, debugger 324 can be located remotely to computer 300. In such a case, branch history snapshot 322 including branch history data 314 is sent to the remote debugger by means of a network connection, such as network 102 in FIG. 1. The remote debugger can be located on a remote client computer and/or a remote server computer, such as servers 104-106 and/or clients 110-114 in FIG. 1.

Thus, in the illustrative example shown in FIG. 3, processor 310 stores the addresses of branch instructions, referred to as branch history data 314, in branch history table 312. Branch history table 312 is stored in a circular buffer, such as buffer 308 on the CPU chip. If an exception condition occurs, processor 310 saves branch history data 314 as branch history snapshot 322 in main memory 320 to preserve the branch history data for use in debugging operations. When operating system 302 detects an exception condition, operating system kernel 304 can retrieve branch history data 314 from main memory 314 to use for debugging. In this manner, branch instructions are more easily identified and defective or problematic instructions can be located by a debugger and/or a user performing debug operations.

In this example, branch history data 314 is saved in main memory 320 when an exception is detected. In another illustrative embodiment, branch history data 314 is saved in non-volatile random access memory (NVRAM). Processor 310 can save branch history data 314 to NVRAM rather than main memory 320 if a serious exception occurs which is so bad that a debugger cannot be safely entered, such as a machine check, the processor can save branch history data from the branch history table into non-volatile random access memory (NVRAM) instead of saving the branch history data in main memory. During the next reboot, the branch history data can be retrieved from the NVRAM and used to debug the problem that resulted in the crash.

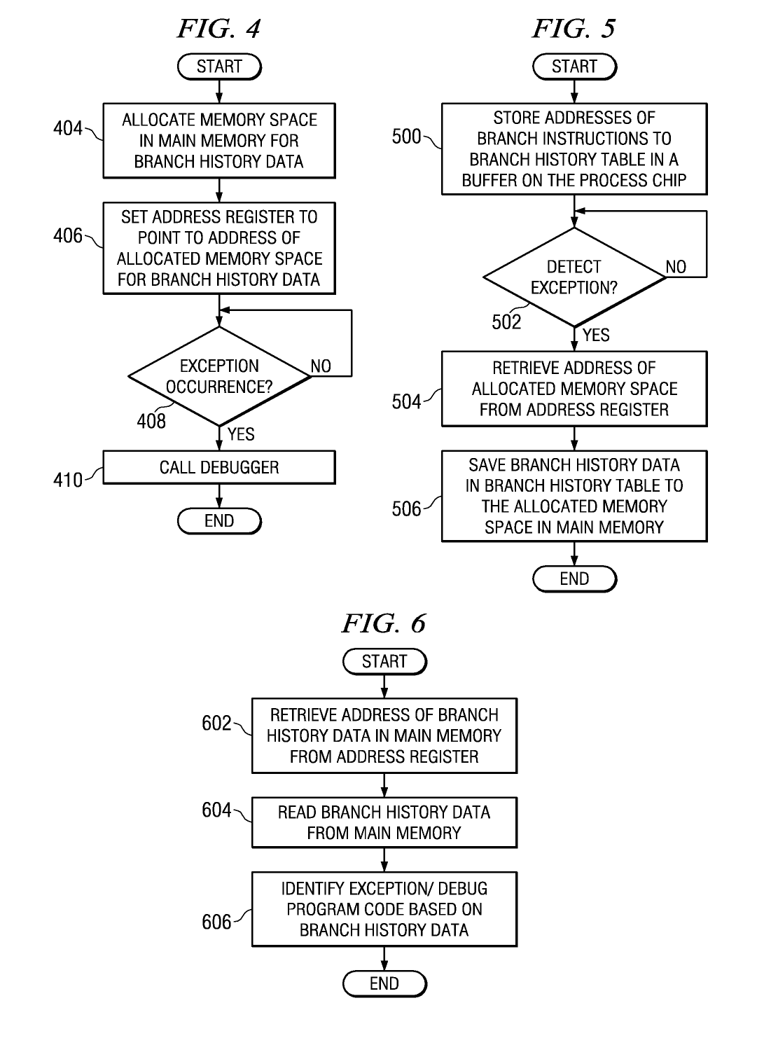

FIG. 4 is a flowchart illustrating a process for creating a branch history table in accordance with an illustrative embodiment. In this illustrative example shown in FIG. 4, the process is performed by a software component for managing resources on a computer, such as kernel 304 of FIG. 3.

The kernel begins by allocating memory space in main memory for branch history data during initialization of computer systems at boot (step 404). The kernel sets an address register on the processor chip to point to an address of the location of the allocated memory space for the branch history data (step 406). The kernel makes a determination as to whether an exception occurrence is detected (step 408). If an exception is not detected, the process returns to step 408 until an exception is detected. When an exception is detected, the kernel calls a debugger, such as debugger 324 in FIG. 3 (step 410) with the process terminating thereafter.

Turning now to FIG. 5, a flowchart illustrating a process for saving branch history data from a branch history table to main memory for use in debugging is shown in accordance with an illustrative embodiment. In this illustrative example shown in FIG. 5, the process is performed by a processor for managing resources on a computer, such as processor 310 of FIG. 3. In this illustrative example, the processor is a central processing unit (CPU).

The process begins by storing addresses of branch instructions in executing code to a branch history table in a buffer on the processor chip (step 500). During this step, the process saves an address for each executed branch instruction to the branch history table. The process also saves an order in which each branch instruction is executed.

The process makes a determination as to whether an exception is detected (step 502). If an exception is not detected, the process returns to step 500 and continues storing addresses to branch instructions to the branch history table. If the branch history table in the buffer becomes full, the process overwrites new branch instruction addresses over old branch instruction addresses in a round robin fashion, such that new data is written over the oldest branch instruction data in the branch history table. This process continues until an exception is detected at step 502.

When an exception is detected, the process retrieves an address of the allocated memory space for a branch history table on the processor from an address register, such as address register 318 in FIG. 3 (step 504). The process saves branch history data in the branch history table to the allocated memory space in main memory (step 506) with the process terminating thereafter.

FIG. 6 is a flowchart illustrating a process for accessing branch history data by a debugger in accordance with an illustrative embodiment. In this illustrative example shown in FIG. 6, the process is performed by a component for debugging code, such as debugger 324 of FIG. 3.

The debugger begins by retrieving an address of branch history data in main memory from an address register, such as address register 318 in FIG. 3 (step 602). The debugger reads branch history data from main memory (step 604). Branch history data is stored in main memory as a branch history snapshot, such as branch history snapshot 322 in FIG. 3. The debugger identifies the exception or debugs the program based on the branch history data (step 606) with the process terminating thereafter.

The illustrative embodiments provide computer implemented method, apparatus, and computer program product for preserving branch history data. In one example, the process creates a branch history table in a buffer. The process saves an address for each executed branch instruction to the branch history table to form a set of branch history data. In response to detection of an exception, the process saves the set of branch history data to an allocated memory space to form a branch history snapshot.

In this manner, a separate branch history table is created which stored the last “X” amount of branch addresses. The “X” amount of branch addresses is any number of branch addresses or any set of branch addresses. The table is stored on the processor's silicon wafer for quick access by the processor and/or operating system. The processor also utilizes a register which points to a memory location allocated for saving branch history data to main memory. The operating system allocates this memory location and writes the address of this memory location back to the register. The operating system can allocate the memory space by calling a function, such as malloc( ). When an exception occurs, the processor takes a snapshot of the branch history table, and writes it to the memory address specified in the register. If the exception was bad enough to cause the operating system to call a debugger, the operating system can check the memory location where the last snapshot was stored to see how the crash occurred.

When the operating system debugger runs code to initialize itself and read the table, if the debugger code executes branches, the branch instructions would be saved to the branch history table in the buffer, thus corrupting the branch history data in the buffer. However, the illustrative embodiments preserve the branch history data at the time of the exception condition by saving the branch history data as a snapshot in main memory. Thus, the branch history data is available for use by the debugger to identify the instruction that caused the exception and/or crash.

The illustrative embodiments provide branch history data through a function to access a branch history table. Branch history data includes addresses of branch instructions, information regarding which branch instructions were executed and which branch instructions were not executed, the order in which the branch instructions were executed, and any other information regarding branch instructions. Branch history data is used in debugging operations. In this manner, debugging is possible during a first failure scenario. Thus, the illustrative embodiment preserve branch history data needed for debugging operations.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for preserving branch history data, the computer implemented method comprising:
creating a branch history table in a buffer;
saving an address for each executed branch instruction that occurs during execution of code in the branch history table to form branch history data;
responsive to detection of an exception, saving the branch history data to an allocated memory space to form a branch history snapshot.

2. The computer implemented method of claim 1 wherein the allocated memory space is a memory location in main memory.

3. The computer implemented method of claim 1 wherein the allocated memory space is a memory location in non-volatile random access memory.

4. The computer implemented method of claim 1 further comprising:
retrieving the branch history snapshot from the allocated memory space for use in performing a debugging operation, and wherein the branch history snapshot identifies addresses of executed branch instructions.

5. The computer implemented method of claim 1 further comprising:
sending the branch history snapshot to a debugger on a remote data processing system for use in performing debugging operations.

6. The computer implemented method of claim 1 further comprising:
setting a register to point to the allocated memory space.

7. The computer implemented method of claim 6 wherein the step of saving the set of branch history data to an allocated memory space further comprises:
checking the register to determine a location of the allocated memory space; and
saving the branch history data to the allocated memory space pointed to by the register.

8. The computer implemented method of claim 1 further comprising:
responsive to a determination that the exception requires debugging, calling a debugger, wherein the debugger retrieves the branch history snapshot and performs a debug operation based on the branch history snapshot.

9. The computer implemented method of claim 1 wherein the buffer is a circular buffer located on a processor chip.

10. The computer implemented method of claim 1 further comprising:
reading branch history data from the branch history snapshot; and
identifying an instruction causing the exception based on the branch history data.

11. A computer program product comprising:
a computer usable medium including computer usable program code for preserving branch history data, said computer program product comprising:
computer usable program code for creating a branch history table in a buffer;
computer usable program code for saving an address for each executed branch instruction that occurs during execution of code in the branch history table to form branch history data; and
computer usable program code for saving the branch history data to an allocated memory space to form a branch history snapshot in response to detection of an exception.

12. The computer program product of claim 11 wherein the allocated memory space is a memory location in main memory.

13. The computer program product of claim 11 further comprising:
computer usable program code for allocating a memory space in main memory for the branch history snapshot to form the allocated memory space.

14. The computer program product of claim 11 further comprising:
computer usable program code for retrieving the branch history snapshot from the allocated memory space for use in performing a debugging operation, and wherein the branch history snapshot identifies addresses of executed branch instructions.

15. The computer program product of claim 11 further comprising:
computer usable program code for sending the branch history snapshot to a debugger on a remote data processing system for use in performing debugging operations.

16. The computer program product of claim 11 further comprising:
computer usable program code for setting a register to point to the allocated memory space.

17. An apparatus comprising:
a bus system;
a communications system connected to the bus system;
a memory connected to the bus system, wherein the memory includes computer usable program code; and
a processing unit connected to the bus system, wherein the processing unit executes the computer usable program code to create a branch history table in a buffer; save an address for each executed branch instruction that occurs during execution of code in the branch history table to form branch history data; and save the branch history data to an allocated memory space to form a branch history snapshot in response to detection of an exception.

18. The apparatus of claim 17 wherein the processor unit further executes the computer usable program code to retrieve the branch history snapshot from the allocated memory space for use in performing a debugging operation, and wherein the branch history snapshot identifies addresses of executed branch instructions.

19. A system for preserving branch history data, the system comprising:
a processor, wherein the processor creates a branch history table in a buffer and saves an address for each executed branch instruction to the branch history table during the execution of code to form branch history data;
the branch history table, wherein the branch history table stores the branch history data; and
an operating system for saving the branch history data to an allocated memory space to form a branch history snapshot in response to detection of an exception.

20. The system of claim 19 further comprising:
a debugger, wherein the debugger retrieves the branch history snapshot from the allocated memory space for use in performing a debugging operation, and wherein the branch history snapshot identifies addresses of executed branch instructions.
